(19) United States
(12) Patent Application Publication
(10) Pub. No.: US 2006/0190689 A1
(43) Pub. Date: Aug. 24, 2006

(54) Method of addressing data in a shared memory by means of an offset

(75) Inventor: Paulus Adrianus Wilhelmus Van Niekerk, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/549,643

(22) PCT Filed: Mar. 19, 2004
(86) PCT No.: PCT/IB04/50291

§ 371 Date: Sep. 20, 2005

(30) Foreign Application Priority Data
Mar. 25, 2003 (EP) 03100773.5

(51) Int. Cl. G06F 13/28

(52) U.S. Cl. 711/147; 711/220

(57) ABSTRACT

This invention relates to a first method of referencing a first number for data (29) to be stored and a second method of referencing a first address for data to be retrieved. Said data is shared among a producer and a consumer. Said first method comprising the steps of computing said first number (24, offset) equalling p (25) minus Vaprod (26), wherein p is in the virtual address space of the producer, and Vaprod is in the virtual address space of the producer (20); and storing said first number as the address for said data in a scatter gather list. Optionally said first method comprises the step of storing (300) data at location p. Said second method comprises the steps of the retrieving (400) a second number from a scatter gather list, wherein said second number (24, offset) equals p (25) minus Vaprod (26), wherein p is in the virtual address space of the producer, and Vaprod is in the virtual address space of the producer; and computing (500) said first address (27, q) as a VAcons (28) plus said second number, wherein said VAcons is the consumer adress for the scatter gather list in the virtual address space of said consumer (21), and where said first address is in the virtual address space of said consumer. Optionally said second method comprises the step of retrieving (600) data, wherein said retrieved data is pointed to by said first address. Hereby the producer can communicate data to the consumer, even though the consumer has a different virtual address space than that of the producer when said methods are used in conjunction.

This invention relates to a first method of referencing a first number for data to be stored, where data is shared among a producer and a consumer.

This invention further relates to a second method of referencing a first address for data to be retrieved or read, where data is shared among the producer and the consumer.

The present invention also relates to a computer system for performing each of the methods.

The present invention further relates to a computer program product for performing each of the methods.

Additionally, the present invention relates to uses of the first and second method between processors, i.e. for data storage and retrieval to/from processors, respectively, where the processors have memory attached to them.

The present invention is in the field of applied scatter gather lists, SGLs. In most computer systems, the memory of a data buffer can be “scattered,” rather than contiguous. That is, different “fragments” of the buffer may physically reside at different memory locations. When transferring a “scattered” buffer of data from, for example, the main memory of a host computer to a secondary storage device, it is necessary to “gather” the different fragments of the buffer so that they preferably can be transferred to the secondary storage device in a more contiguous manner. Scatter-gather lists are commonly used for this purpose. Each element of a scatter-gather list points to a different one of the buffer fragments, and the list effectively “gathers” the fragments together for the required transfer. A memory controller, such as a Direct Access Memory (DMA) controller, then performs the transfer as specified in each successive element of the scatter-gather list.

U.S. Pat. No. 6,434,635 discloses a method and an input/output adapter of data transfer using a scatter gather list. The scatter gather list is used to transfer a buffer of data of a certain length from a first to a second memory. A pad of another certain length is inserted after each of successive portions of a length of the data is transferred by means of a newly generated and updated scatter gather list. Each scatter gather list element specifies start and length of data segments. Said transfer can be performed by means of Direct Memory Access controller as an example of said input/output adapter.

Typically, a producer and a consumer of data share main memory. However, the virtual address space of the producer differs from the virtual address space of the consumer. A problem arises when the producer wants to communicate data from shared memory to the consumer. The SGL of the producer contains a reference to the address of the data in the virtual address space of the producer. Correspondingly, the SGL of the consumer contains a reference to the address of the same data in his virtual address space. The problem is, how can the producer communicate this data to the consumer, since the consumer has a different virtual address space than that of the producer. The same problem applies to physical memory, e.g. for physical memory being in different address maps of processors.

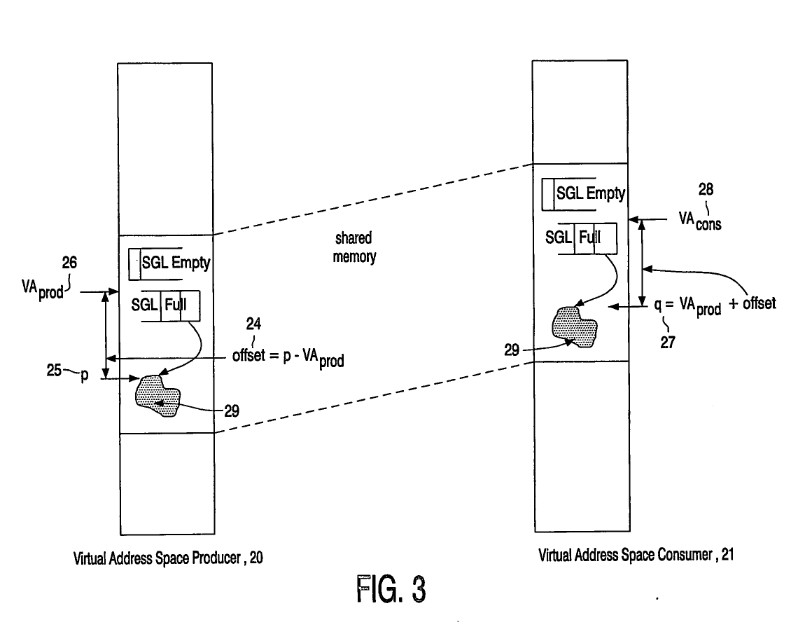

The above problem is solved by said methods as claimed and as shown especially in the FIGS. 3, 4 and 5.

It is an advantage of the invention that all the pointer-arithmetic that is usually associated with keeping track of used/free memory is now hidden by the SGLs.

It is an additional advantage of the invention that it can be applied for main memory as well as storage devices and other address spaces.

It is a further advantage of the invention that the FIFO behaviour of the SGLs makes them a natural asynchronous interface between layers in a system, e.g. application and file system, but also on lower layers, i.e. said advantage applies for uni-processor systems and for multi-processor shared memory systems as well.

Said computer system and computer program product, respectively provides the same advantages and solves the same problem for the same reasons as described previously in relation to the methods in conjunction and separately.

The invention will be explained more fully below in connection with preferred embodiments and with reference to the drawings, in which:

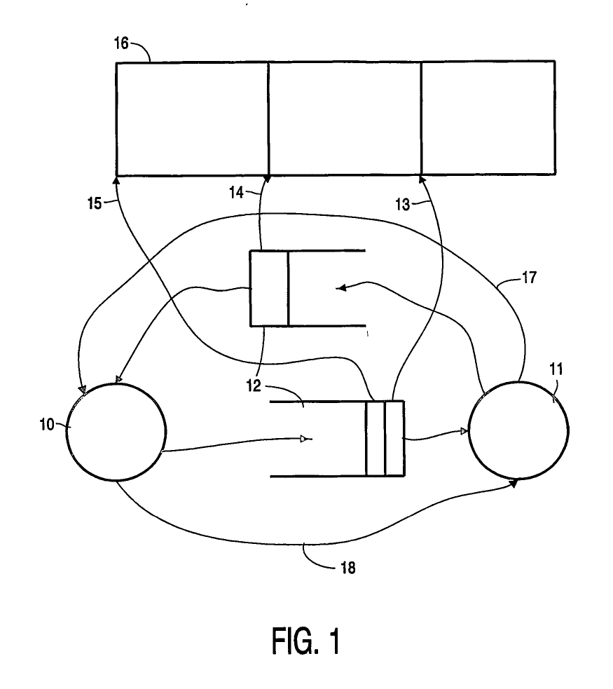

FIG. 1 shows how a producer and a consumer operate on two scatter gather lists.

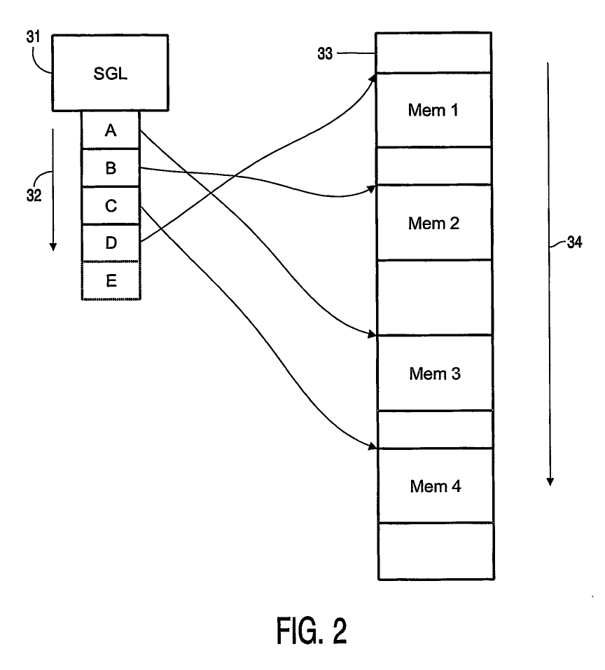

FIG. 2 shows the functional context of a scatter gather list;

FIG. 3 shows an example of scatter gather lists in shared memory;

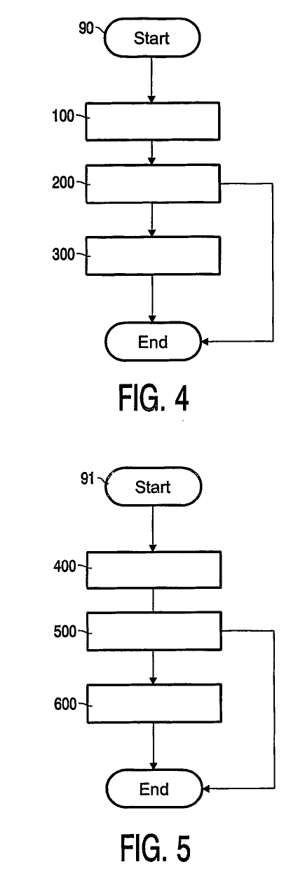

FIG. 4 shows a method of referencing a first number for data to be stored; and

FIG. 5 shows a method of referencing a first address for data to be retrieved.

Throughout the drawings, the same reference numerals indicate similar or corresponding features, functions, lists, etc.

FIG. 1 shows how a producer and a consumer operate on two scatter gather lists.

A Scatter Gather List (SGL) may be an abstract data type (ADT) that describes a logical sequence of main memory locations. However, it is known in the art that the SGL may comprise less abstract data types. Said logical sequence of main memory locations need not be consecutive, i.e., they may be scattered over memory. Locations can typically be added at the logical end, and locations can only be obtained and removed from the logical start of the SGL. The API, application programmer's interface allows SGLs, reference numeral 12, to be used as FIFO mechanisms between a producer, reference numeral 10 and a consumer, reference numeral 11, as long as there is at most one producer and one consumer, i.e. without additional synchronization methods. The single producer and the single consumer are synchronized automatically. Synchronization between multiple producers needs additional methods, such as critical regions, mutexes, semaphores, etc. For multiple consumers this is also the case. Pointers, reference numerals 13, 14 and 15 are shown to generally indicate how reference numeral 16, a memory for circular buffer data is maintained and referenced to by said Scatter Gather List. Typically said pointers will keep track of on which address data (from the producer) is written or stored, correspondingly another pointer will keep track of from which address data (from the consumer) is read or retrieved. From the art it is known that pointers generally can be used to maintain a FIFO mechanism between the producer and the consumer (of data).

A typical usage example is the circular buffer (reference numeral 16), where both the full part and the empty part are easily described using an SGL assuming that the memory holding the data of the circular buffer is contiguous, the Empty SGL contains a single unit, i.e. a single tuple containing address and length of a contiguous piece of memory, or two such units if the empty part is split. In this example, the Full SGL has two such units, starting with the unit describing the oldest data. The wrap around of the buffer can be in the Empty SGL, the Full SGL, or neither. On top of the SGLs, a mechanism is optionally applied for synchronization between producer and consumer, in this example by trigger, reference numeral 17 and call-back functions, reference numeral 18. The synchronization mentioned here is different from the above-mentioned. Here it is applied to prevent polling.

The trigger and call back functions typically only perform an release, signal or similar operation in order to maintain separation of the execution contexts of the producer and the consumer. The memory for the circular buffer need not be contiguous: in that case the SGLs would simply contain more units.

Said function names (trigger, call-back) are typical when the producer and consumer are in different layers. Otherwise this could just directly be operations on semaphores, queues, etc.

All data described by a SGL must belong to the same address space, so for some SGL this could be all virtual memory or all physical memory, but combinations thereof are not allowed. The reason for this is that the SGL API combines units that are both logically contiguous and contiguous in memory.

This combining of fragments is also known as “de-fragmentation”. Such de-fragmentation is optional, i.e., it is not required. It is of course beneficial in terms of resource usage (CPU, memory, etc).

A SGL could even be used to describe data residing on a small IDE HDD, e.g. in terms of logical block addresses and number of sectors. Said SGL may be applied by means of one or more processors belonging to a multi-processor system. Hereby said processors—with corresponding memory attached to them—can perform reading and writing of data according to the invention.

It is therefore an advantage of the invention that it can be applied for main memory and other address spaces, and that it can be applied in said multi-processor system.

When the producer produces data, and the consumer consumes the same data certain rules must be respected to ensure consistency of the scatter-gather lists.

The consumer obtains memory with data from the full SGL, consumes it, and adds the memory to the empty SGL.

It is therefore an advantage of the invention that the FIFO behaviour of the SGLs makes them a natural asynchronous interface between layers in a system, e.g. application and file system and/or on lower layers as well.

Both the producer and the consumer may obtain length or size of the SGL. The length returned denotes the total size of the data described by the scatter-gather list.

If the SGL resides in shared memory, and the SGL only describes locations in that same shared memory, the SGL can be used from all (virtual) memory spaces that have this shared memory in their map. That piece of shared memory is then considered to be the “same address space” as described above, but it can thus be visible from several other address spaces. The API in these cases always uses the virtual addresses of the address space of the process calling the particular API. Since the start address of the shared memory can be different for different memory spaces, the SGL structure—according to the present invention—internally maintains offsets with respect to its own virtual address, as shown in FIG. 3.

It is therefore an additional advantage of the invention that the SGLs can be used as part of an API specification.

FIG. 2 shows the functional context of a scatter gather list. The SG-List, reference numeral 31 is used to describe a logical sequence of data as indicated by the arrow direction of reference numeral 32. Data may be scattered all over the memory. The data described by the SG-List may be located in data-areas of different sizes, i.e. Mem 1, Mem 2, etc may have different sizes. The arrow direction of reference numeral 34 describes the memory address order in memory, reference numeral 33.

The SG-List instantiation as seen in the figure has a fixed number of scatter-gather units (i.e. A, B, C, D and E) and describes the logical sequence of data, i.e. Mem 3, Mem 2, Mem 4 and Mem 1. The SG-List instantiation in the figure is not completely filled; one additional contiguous data-area can be appended, i.e. in SG-unit E. Note that the order of the logical data (A, B, C, D) does not have to be the same as the memory-address order.

Further note that shown units (A through E) are internal to the SGL.

FIG. 3 shows an example of scatter gather lists in shared memory. The shared memory is as indicated between the two broken lines. Reference numeral 20 shows the virtual address space of the producer, and reference numeral 21 shows the virtual address space of the consumer.

Note that both producer and consumer operate on both SGLs, but on a different end of the SGLs: the producer perform operations such as obtain memory/data and remove memory on the “Empty” SGL and an append operation on the “Full” SGL. For the consumer it is the other way around.

As discussed, since the start address of the shared memory can be different for different memory spaces, said methods—according to the present invention—each, internally maintain offsets with respect to its own virtual address, as shown in this figure. Said methods will be discussed by means of FIGS. 4 and 5, respectively.

The problem was how the producer communicates data to the consumer since the consumer has a different virtual address space than that of the producer. In fact, both address spaces contain both SGLs, since both SGLs are in the shared memory. Here, the producer appends on the full SGL, and the consumer performs operations such as obtain memory/data and remove (data) from the same full SGL. The problem is that the virtual address of this same full SGL can be different in the two address spaces. The problem is solved since the producer knows the address of the SGL in his virtual address space, i.e. VAprod, reference numeral 26 and, correspondingly, the consumer knows the address of the SGL in his virtual address space, i.e. VAcons, reference numeral 28.

In other words, the producer as well as consumer know their virtual addresses of both the Empty SGL and the Full SGL, i.e. both producer and consumer operate on both SGLs, but—of course—from different ends. The address of the data to be communicated is p in the address space of the producer. Instead of storing this address p in the SGL, the offset of p with respect to the address of the Full SGL is stored (offset=p−VAprod) in the Full SGL.

The API called by the consumer to retrieve addresses from this same SGL is used to construct the address of the data (q), reference numeral 27 in the virtual address space of the consumer (q=VAcons+offset). As can be seen, said offset is used to link between the virtual address spaces, i.e. VAcons and VAprod.

FIG. 4 shows a method of referencing a first number for data to be stored. The figure corresponds to explanation given in FIG. 3 with respect to the offset of p with respect to the address of the SGL which is stored, i.e. offset=p—VAprod in the SGL.

This method comprises the following two steps.

In step 100, said first number is computed. It equals p minus Vaprod. Said p is in the virtual address space of the producer, and Vaprod is in the virtual address space of the producer.

In step 200, said first number is stored as the address for said data in said scatter gather list.

It is further possible in this step to store a length of said data.

The method may further comprise step 300.

Data is here stored. Said data is stored at location P. Typically, data is stored first, and only then appended the memory to the SGL, otherwise a race condition would exist, i.e. where the consumer already gets the address before the data is stored by the producer.

FIG. 5 shows a method of referencing a first address for data to be retrieved. The figure corresponds to explanation given in FIG. 3 with respect to the offset of p with respect to the address of the said SGL which is stored, i.e. (offset=p−VAprod) in the said SGL. This figure further relates to how and where the offset is used again, i.e. this computed offset is used by the SGL to construct the address of the data (Q) in his virtual address space, i.e. q=VAcons+offset.

The method of referencing a first address for data to be retrieved comprises the following two steps:

In step 400, a second number is retrieved from the scatter gather list. Said second number was previously computed during the add data operation on the SGL. It equals p minus Vaprod. Said p is in the virtual address space of the producer, and Vaprod is in the virtual address space of the producer.

This step corresponds to step 100 of the previous figure.

In step 500, said first address, q is computed. It is VAcons plus said second number. Said VAcons is the consumer address for the scatter gather list in the virtual address space of said consumer, and said first address is in the virtual address space of said consumer.

An obtain memory/data function or operation may then return the calculated address, i.e. said first address, q.

Said method may further comprise the following step 600.

Data is here retrieved or read. Said data is pointed to by said first address.

A computer readable medium may be magnetic tape, optical disc, digital versatile disk (DVD), compact disc (CD record-able or CD write-able), mini-disc, hard disk (IDE, ATA, etc), floppy disk, smart card, PCMCIA card, etc.

The discussed first method may be used for data storage in a multiprocessor system.

The discussed second method may be used for data retrieval performed by a processor in a multiprocessor system.

In the claims, any reference signs placed between parentheses shall not be constructed as limiting the claim. The word “comprising” does not exclude the presence of elements or steps other than those listed in a claim. The word “a” or “an” preceding an element does not exclude the presence of a plurality of such elements.

The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. A method of referencing a first number for data (29) to be stored, where data is shared among a producer (10) and a consumer (11), said method comprising the steps of:
computing (100) said first number (24, offset) equalling p (25) minus Vaprod (26), wherein p is in the virtual address space of the producer, and Vaprod is in the virtual address space of the producer (20); and
storing (200) said first number as the address for said data in a scatter gather list.

2. A method of referencing a first number for data to be stored according to claim 1 further comprising the step of:
storing (300) data at location p.

3. A method of referencing a first address for data to be retrieved, where data is shared among a producer and a consumer, said method comprising the steps of:
retrieving (400) a second number from a scatter gather list, wherein said second number (24, offset) equals p (25) minus Vaprod (26), wherein p is in the virtual address space of the producer, and Vaprod is in the virtual address space of the producer; and
computing (500) said first address (27, q) as a VAcons (28) plus said second number, wherein said VAcons is the consumer adress for the scatter gather list in the virtual address space of said consumer (21), and where said first address is in the virtual address space of said consumer.

4. A method of referencing a first address for data to be retrieved according to claim 3 further comprising the step of:
retrieving (600) data, wherein said retrieved data is pointed to by said first address.

5. A computer system for performing the method according to claim 1.

6. A computer system for performing the method according to claim 3.

7. A computer program product comprising program code means stored on a computer readable medium for performing the method of claim 1 when the computer program is run on a computer.

8. A computer program product comprising program code means stored on a computer readable medium for performing the method of claim 3 when the computer program is run on a computer.

9. Use of the method according to claim 1 for data storage in a multiprocessor system.

10. Use of the method according to claim 3 for data retrieval in a multiprocessor system.
